(19) United States
(12) Patent Application Publication
(10) Pub. No.: US 2012/0266760 A1
(43) Pub. Date: Oct. 25, 2012

(54) OUTDOOR GRILL WITH INTEGRATED GRIDDLE

(76) Inventors: Donald William BRYCE, Natick, MA (US); Robert Scott Ashworth, Littleton, MA (US); Paul Santarsiero, Avon, CT (US)

(21) Appl. No.: 13/438,184

(22) Filed: Apr. 3, 2012

Related U.S. Application Data
(60) Provisional application No. 61/476,780, filed on Apr. 19, 2011.

(51) Int. Cl. A47J 37/07

(52) U.S. Cl. 99/448

(57) ABSTRACT

Disclosed is a grill including a firebox having a burning chamber and an open upper end, a first horizontal cooking surface disposed over the burning chamber, a domed lid resting atop the burning chamber and enclosing the first horizontal cooking surface and having an opening through a top side thereof, and a panel resting atop the opening in either a first position in which the panel is a lid portion to close the opening, or a second position in which the panel serves as a second horizontal cooking surface disposed above the first horizontal cooking surface and exposed to the burning chamber through the opening.

### RELATED APPLICATION

This application is a Continuation of and claims the benefit of pending U.S. Provisional Application Ser. No. 61/476,780, filed Apr. 19, 2011, the entire teachings of which are incorporated herein by reference.

### FIELD OF THE INVENTION

The present invention is related to cooking of food. Preferably, this invention is related to an outdoor grilling apparatus having means for frying or sautéing a secondary food item simultaneous to the grilling of the primary food item. More preferably, aside for having a grilling surface for the enclosed grilling of typical food items such as meats, the grilling apparatus is equipped with a removable accessory cooking device, closing a hole atop the lid of the grilling apparatus to serve as a portion of the lid when not in use, or receiving heat through that hole to serve as a skillet for the open-air frying or sautéing of such food items as vegetables.

### BACKGROUND

Outdoor grills are well known, but include numerous drawbacks and disadvantages, including the inability to simultaneously cook different foods in differing manners. While accessories have been offered to attempt to allow a multiplicity of foods to be cooked simultaneously side-by-side on the same grilling surface, these are all found to force a compromise between the best cooking conditions of one of the foods or the other. As such, existing grills have proven limited to properly cooking only one type of food at a time.

There exists a need for improvement in the versatility of outdoor grilling, and such is an object of the present invention. There exists the need for differing foods to be simultaneously and properly cooked by a single outdoor grill, and such is an object of the present invention. Further needs and objects exist which are addressed by the present invention, as may become apparent upon review of the included disclosure of exemplary embodiments thereof.

### SUMMARY OF THE INVENTION

The invention may be practiced in an outdoor grill having a firebox for holding and burning a fuel, such as propane, charcoal, or wood, which firebox is covered by a perforated cooking grate, on which foods, such as meats, are grilled. A lid covers the firebox and is removable there-from to access both the cooking grate and the fuel burning area of the firebox. The lid includes an upper surface having a large opening there-through. A removable panel is adapted to cover the opening. The removable panel may simply serve as a continuation of the lid if, for instance, the grill us being used only to grill primary food items, such as meats, on the internal grate. Alternatively, the panel may serve as a removal skillet on which such secondary food items as vegetables, seafoods, or small food items are fried or sautéed, using the heat rising within the firebox from the burning fuel. As a third option, the panel may be removed and set aside to allow open-air grilling on the grate while allowing the peripheral walls of the open-topped lid to contain splatter and flames.

In an exemplary embodiment, the invention is practiced in a grill including a firebox having a shell having an open upper end, a burning chamber within the shell below the open upper end and in which a fuel is burned, a cooking grate disposed over the burning chamber and forming a first cooking surface disposed to be heated by the burning fuel, a lid resting atop the firebox and including an opening in a top side thereof and there-through toward the cooking grate, and a panel removably resting atop and covering the opening, the panel including a second cooking surface disposed above the first cooking surface to be heated by the burning fuel. The second cooking surface may be planar. The second cooking surface may be horizontally disposed. The second cooking surface may be surrounded by an upwardly projecting peripheral wall. The second cooking surface may be treated to retard sticking of foods during cooking, such as with polytetrafluoroethylene. The second cooking surface may alternatively be concave and/or may include one or more features from the group including ribs, protrusions, slots, and holes.

The invention may also be practiced in a grill including a burning chamber adapted to burn fuel to cause heat, a perforated cooking grate disposed over the burning chamber to form a grilling surface receiving heat from the burning chamber, a lid resting atop the burning chamber and having an opening in a top side thereof and through to the perforated cooking grate, and a non-perforated panel removably resting atop and covering the opening, the panel including a frying surface disposed above the grilling surface and receiving heat from the burning chamber. The frying surface may be planar. The frying surface may be horizontally disposed. The frying surface may be surrounded by an upwardly projecting peripheral wall. The frying surface may be treated to retard sticking of foods during cooking, such as with polytetrafluoroethylene. The frying surface may alternatively be concave and or may include one or more features from the group including ribs and protrusions.

The invention may also be practiced in a grill including a firebox having a burning chamber and an open upper end, a first horizontal cooking surface disposed over the burning chamber, a domed lid resting atop the burning chamber and enclosing the first horizontal cooking surface and having an opening through a top side thereof, and a panel resting atop the opening in either a first position in which the panel is a lid portion to close the opening, or a second position in which the panel serves as a second horizontal cooking surface disposed above the first horizontal cooking surface and exposed to the burning chamber through the opening. The second horizontal cooking surface may planar. The second horizontal cooking surface may be surrounded by an upwardly projecting peripheral wall. The second horizontal cooking surface may be treated to retard sticking of foods during cooking, such as with polytetrafluoroethylene. The second horizontal cooking surface may include one or more features from the group including ribs, protrusions, slots, and holes.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing a representative embodiment for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of an exemplary embodiment for practicing the invention in the form of an outdoor barbeque grill, configured for enclosed grilling;

FIG. 2 is a perspective view of the grill of FIG. 1, configured for enclosed grilling and griddling;

FIG. 3 is a perspective view of the grill of FIG. 1, configured for storage or travel;

FIG. 4 is a fully exploded view of the grill of FIG. 1;

FIG. 5 is a partially exploded view of the grill of FIG. 1;

FIG. 6 is a cross-sectional view through the grill if FIG. 1, configured for enclosed grilling and griddling;

FIG. 7 is a cross-sectional view through the grill if FIG. 1, configured for storage or travel;

FIG. 8 is a cross sectional view of the handles of the legs of grill of FIG. 1 just prior to their connection together;

FIG. 9 is a cross sectional view of the handles of the legs of the grill of FIG. 1 connected together;

FIG. 10 is a top view of the handles of the legs of the grill of FIG. 1 just prior to their connection together;

FIG. 11 is a top view of the handles of the legs of the grill of FIG. 1 connected together;

FIG. 12 is a side view of the left foot of the grill of FIG. 1;

FIG. 13 is a partial cross-sectional view through the connected firebox and lid handles of the grill of FIG. 1;

FIG. 14 is a close up view of the leg pivot of the grill of FIG. 1;

FIG. 15 is a cross section through a leg of the grill of FIG. 1; and

FIG. 16 is a partial cross-sectional view through the griddle handle of the grill of FIG. 1.

### DETAILED DESCRIPTION OF AN EXEMPLARY EMBODIMENT

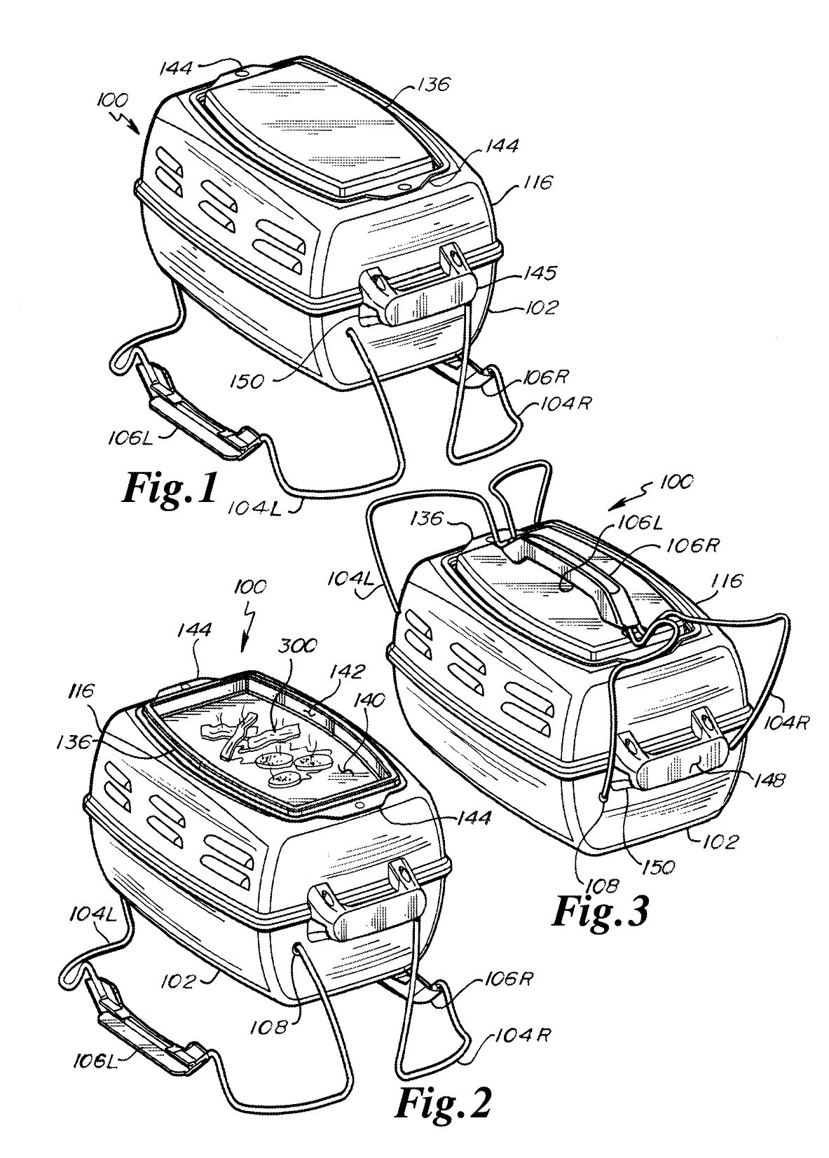

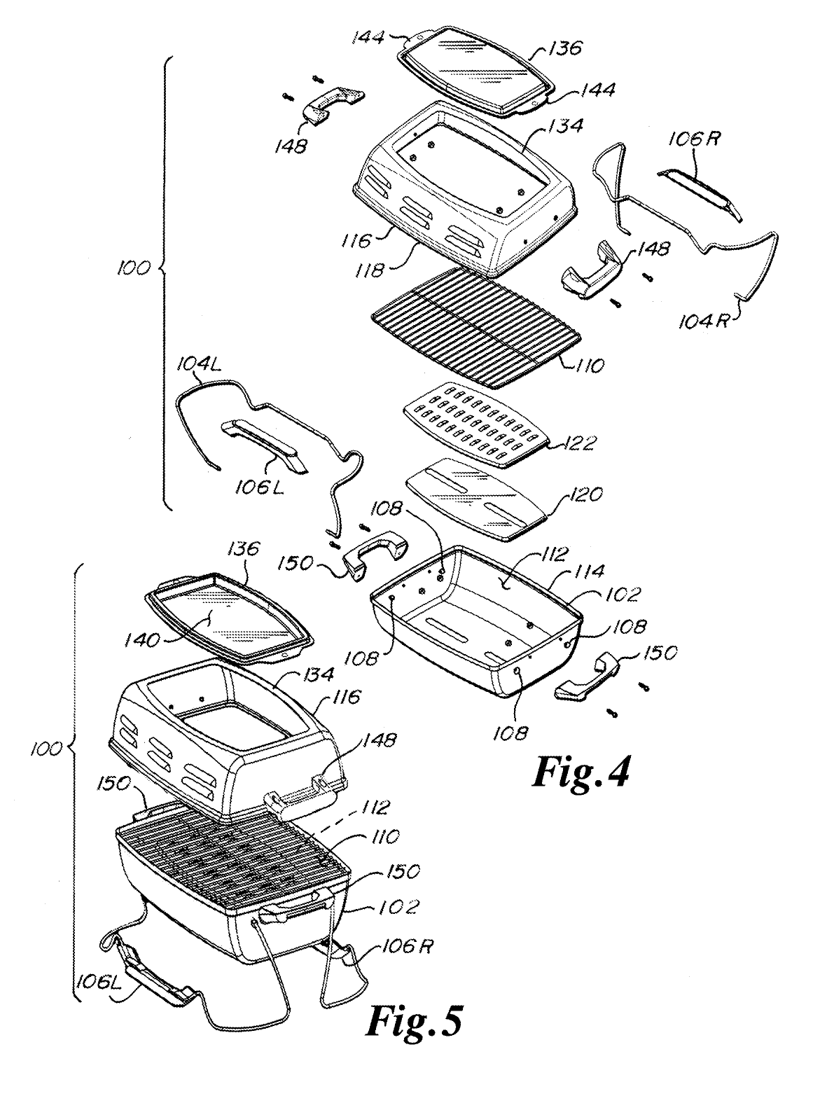

An exemplary barbeque grill 100 for practicing the invention is shown FIGS. 1-15. The grill includes firebox 102 for burning fuel to produce heat for cooking. The fuel may be gas supplied through an external source, charcoal, wood, or any practical alternative. The grill could also be heated by an electrical heating element within the firebox or by placing the firebox over an external source of heat.

The firebox rests on a stand made of two round steel wire legs 104L and 104R, to which plastic handle halves 106L and 106R are respectively affixed. The legs are inserted into holes 108 in the firebox and pivotable relative to the fire box thereat between the cooking configuration shown in FIGS. 1 and 2 and the storage configuration shown in FIG. 3. In the cooking configuration, the legs maintain the sometimes-hot firebox in a horizontal disposition off of a support surface such as the ground, a floor, or a tabletop.

The firebox is bowl-shaped to form a concave shell having an open upper periphery including a rim 114 shaped to receive and support removable cooking grate 110. Within the firebox is burning chamber 112 in which the selected fuel burns to create heat which rises to cook food 200 resting atop the grate.

Lid 116 is generally frusto-domed to form a downwardly directed concave shell having an open lower periphery equal in size and shape the upper periphery of the firebox and having a rim 118 which sealingly mates with and removably rests upon the rim 114 of the firebox. The lid may be lifted from the firebox to access the grate and the burning chamber, such as to add or remove fuel and/or food.

As depicted, the grill is equipped to burn propane gas via a burner 120 and diffuser 122 and propane gas supplied from an external source (not shown), in any of the many known arrangements. As stated, it is also anticipated that the fuel source may be any other reasonable one of the many known fuels used for grilling and barbequing, such as charcoal, coal, wood, etc.

Legs 104L and 104R have attached thereto handle halves 106L and 106R, respectively. The handle halves each are attached to the associated wire leg by screws/washers 124, as shown in FIGS. 9 through 12. In FIGS. 1, 2, 5, and 6, it can be seen how the handle halves serve as feet during use of the grill and how the legs are pivotable about holes 108 in the firebox into both the “use” configurations of FIGS. 1 and 2 and the “storage” configuration of FIG. 3.

In FIG. 14 the insertion of leg 104R though one of holes 108 is shown in closer view, where bulges 130 are formed by stamping each wire leg to expand its width and prevent the leg from intruding into the firebox further than desired. FIG. 15 shows a cross-section of the formed bulge taken at view line 132-132 of FIG. 14.

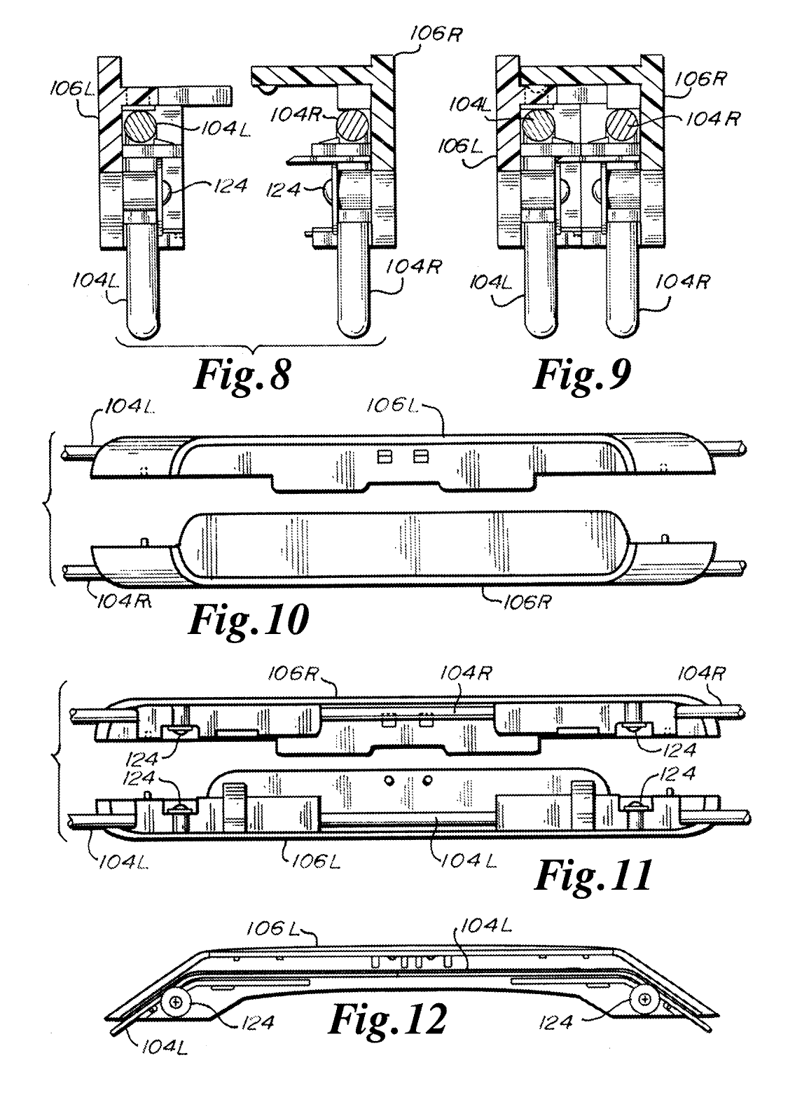

In FIGS. 8 through 12 it can be seen how the two mating handle halves 106R and 106L are adapted to snap together to form a single handle when the legs are pivoted up into the “storage” configuration. As such, the handle formed may be used to conveniently carry the grill with one hand. The legs are shaped so that handle halves may never touch against any of the possible hot surfaces of the grill.

Atop lid 116 is an oval-rectangular opening 134, into and over which formed sheet metal panel 136 may rest and which the panel may close and cover. Referring to FIGS. 1, 2, 6, and 7, the panel is shown in its two configurations, the “griddling” configuration of FIGS. 3 and 6, and the “storage or grilling-only” configuration of FIGS. 1, 3, and 7.

Panel 136 is oval-rectangularly shaped like opening 134 and contoured to serve as either a cover of opening 134 in the “storage or grilling-only” configuration, or to serve as a grill-top griddle in the “griddling” configuration, wherein foods not proper for barbequing or grilling such as on grate 110 may be fried, sautéed or griddled top the grill's closed lid.

Referring to FIGS. 2 and 6, the panel includes a centrally disposed planar cooking surface 140 which is upwardly exposed during the “griddling” configuration. The cooking surface is coated with polytetrafluoroethylene to retard sticking of foods during cooking, and is surrounded by upstanding peripheral wall 142 to contain fats and liquids which may collect on the cooking surface during griddling and prevent those from leaking into the interior of the grill.

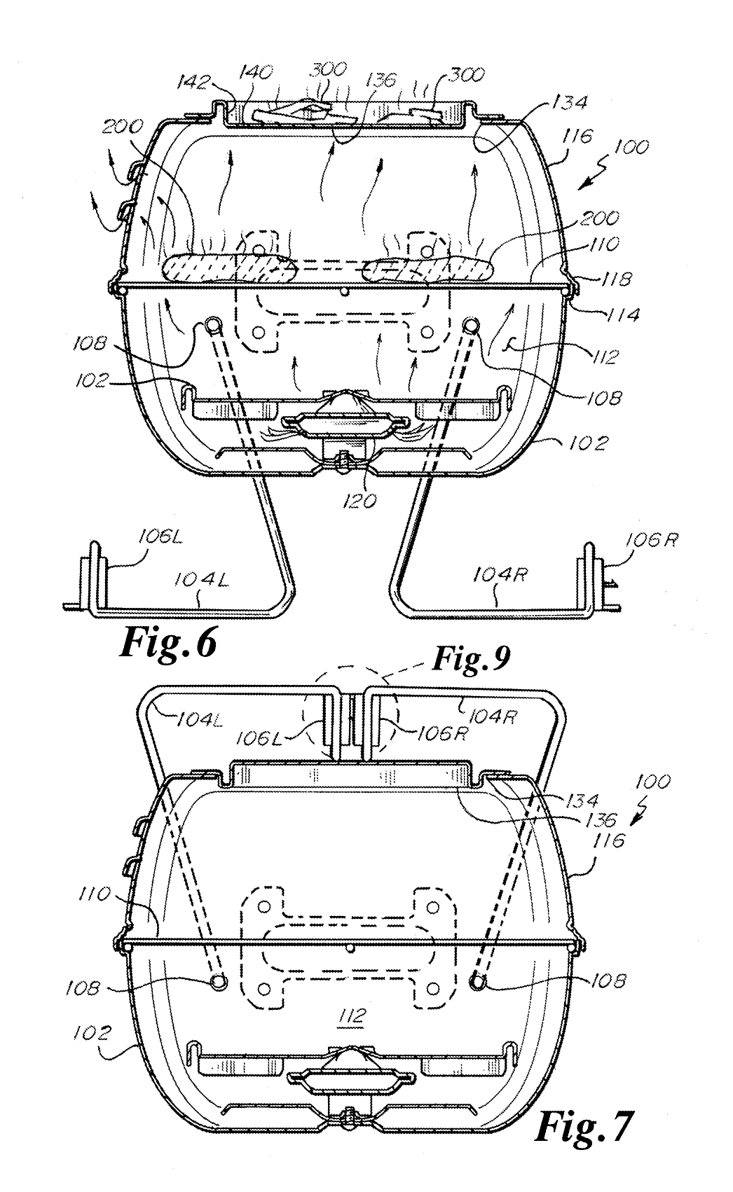

Panel handles 144 project outwardly from the perimeter of the panel and beyond the upper perimeter of the lid, as shown in FIG. 16, so that the panel can be conveniently lifted from the lid. FIG. 16 shows the panel in its “griddling” position, but it can be appreciated from that view that wall 142 extends above handles 144 so that when the panel is in either its “griddling” or flipped into its “storage or grilling-only” position, the wall fits within opening 134 to position the panel properly within and the periphery of the panel lies over the opening, to both maintain the cooking surface in the preferred horizontal disposition and the panel in the proper vertical position. The proper vertical position of the panel during its “storage or grilling-only” position is somewhat important because legs 104L and 104R are configured such that in their “storage” configuration, the legs act a springs to press downwardly against the panel and hold the assembled grill tightly together for transportation, as best appreciated from FIG. 7.

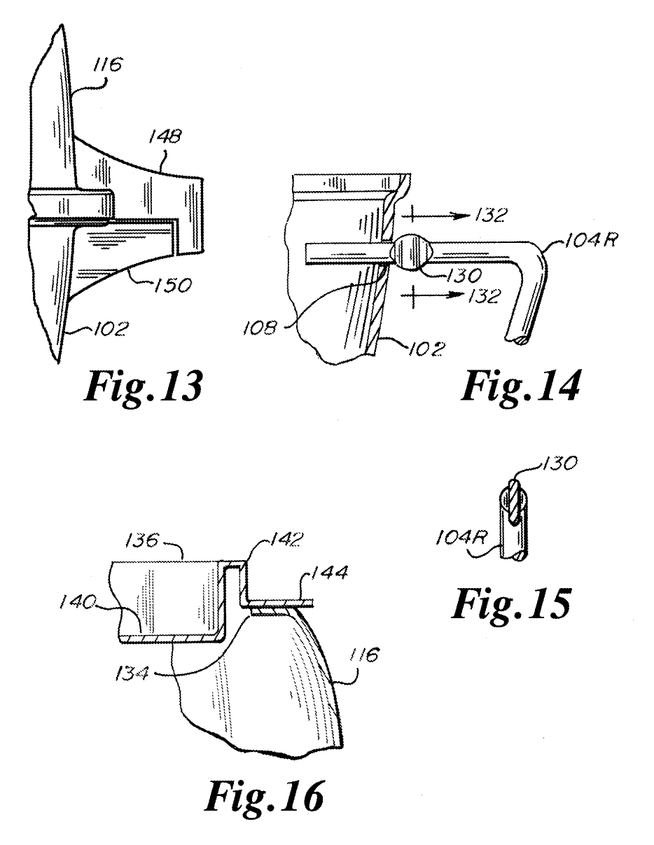

FIG. 13 shows the relationship of lid handles 148 with firebox handles 150, which conveniences either the lifting of just the lid, or the entire grill, according to how the handles are grasped.

While the grill and griddle are shown in their exemplary shapes, the grill may be of any practical shape, such as rectilinear, ovoid, spherical, etc, and the panel may include some other type of secondary cooking surface, such as a wok, a stockpot, a waffle iron, a Panini iron, etc. The panel's periphery may be shaped as shown, may be square, rectangular, oval, round, etc. The panel's cooking surface may be as shown, or may be textured, concave, ribbed, perforated, slotted, etc. Such alternatives, and obvious departures there-from, are all anticipated as being with the invention. Various changes in form and detail may be made without departing from the spirit and scope of the invention, so the invention should therefore only be considered according to the following claims, including all equivalent interpretation to which they are entitled.

We claim:

1. A grill comprising:
a firebox comprising;
a shell having an open upper end;
a burning chamber within the shell below the open upper end and in which a fuel is burned;
a cooking grate disposed over the burning chamber and forming a first cooking surface disposed to be heated by the burning fuel;
a lid resting atop the firebox, and comprising an opening in a top side thereof and there-through toward the cooking grate; and
a panel removably resting atop and covering the opening, the panel comprising a second cooking surface disposed above the first cooking surface to be heated by the burning fuel.

2. The grill of claim 1 wherein the second cooking surface is planar.

3. The grill of claim 2 wherein the second cooking surface is horizontally disposed.

4. The grill of claim 3 wherein the second cooking surface is surrounded by an upwardly projecting peripheral wall.

5. The grill of claim 4 wherein the second cooking surface is treated to retard sticking of foods during cooking.

6. The grill of claim 4 wherein the second cooking surface comprises polytetrafluoroethylene to retard sticking of foods during cooking.

7. The grill of claim 1 wherein the second cooking surface is concave.

8. The grill of claim 1 wherein the second cooking surface includes one or more features from the group including ribs, protrusions, slots, and holes.

9. The grill of claim 1 wherein the second cooking surface is treated to retard sticking of foods during cooking.

10. The grill of claim 1 wherein the second cooking surface comprises polytetrafluoroethylene to retard sticking of foods during cooking.

11. A grill comprising:
a burning chamber adapted to burn fuel to cause heat;
a perforated cooking grate disposed over the burning chamber to form a grilling surface receiving heat from the burning chamber;
a lid resting atop the burning chamber and having an opening in a top side thereof and through to the perforated cooking grate; and
a non-perforated panel removably resting atop and covering the opening, the panel comprising a frying surface disposed above the grilling surface and receiving heat from the burning chamber.

12. The grill of claim 11 wherein the frying surface is planar.

13. The grill of claim 12 wherein the frying surface is horizontally disposed.

14. The grill of claim 13 wherein the frying surface is surrounded by an upwardly projecting peripheral wall.

15. The grill of claim 14 wherein the frying surface is treated to retard sticking of foods during cooking.

16. The grill of claim 14 wherein the frying surface comprises polytetrafluoroethylene to retard sticking of foods during cooking.

17. The grill of claim 11 wherein the frying surface is concave.

18. The grill of claim 11 wherein the frying surface includes one or more features from the group including ribs and protrusions.

19. The grill of claim 11 wherein the frying surface is treated to retard sticking of foods during cooking.

20. The grill of claim 11 wherein the frying surface comprises polytetrafluoroethylene to retard sticking of foods during cooking.

21. A grill comprising:
a firebox comprising a burning chamber and an open upper end;
a first horizontal cooking surface disposed over the burning chamber;
a domed lid resting atop the burning chamber and enclosing the first horizontal cooking surface and having an opening through a top side thereof; and
a panel resting atop the opening in either a first position in which the panel is a lid portion to close the opening, or a second position in which the panel serves as a second horizontal cooking surface disposed above the first horizontal cooking surface and exposed to the burning chamber through the opening.

22. The grill of claim 21 wherein the second horizontal cooking surface is planar.

23. The grill of claim 22 wherein the second horizontal cooking surface is surrounded by an upwardly projecting peripheral wall.

24. The grill of claim 23 wherein the second horizontal cooking surface is treated to retard sticking of foods during cooking.

25. The grill of claim 23 wherein the second horizontal cooking surface comprises polytetrafluoroethylene to retard sticking of foods during cooking.

26. The grill of claim 21 wherein the second horizontal cooking surface includes one or more features from the group including ribs, protrusions, slots, and holes.
